(19) United States
(12) Patent Application Publication
(10) Pub. No.: US 2002/0172549 A1
(43) Pub. Date: Nov. 21, 2002

(54) Cam-operated universal joint apparatus

(76) Inventors: Tibor Koros, Westlake Village, CA (US); Gabriel Koros, Moorpark, CA (US)

Correspondence Address: T. Koros Surgical Instrument Corp, 610 Flinn Avenue, Moorpark, CA, 93021, US

(21) Appl. No.: 10/143,776

(22) Filed: May 14, 2002

Related U.S. Application Data
(63) Continuation of application No. 29/142,036, filed on May 18, 2001, now Pat. No. D455831.

(51) Int. Cl. F16D 1/00

(52) U.S. Cl. 403/322.4

(57) ABSTRACT

A cam-operated universal joint apparatus having a first clamping member, a second clamping member, an axle, and a cam locking mechanism. They are independently positionable to respect each other. The cam locking mechanism further engages the axle that urges upper member and lower member between their clamping and non-clamping position. The second clamping member has an upper portion and a lower portion adjacent to each other. Lower portion of second member selectively engages to upper portion by pivoting around axle. User can rotate lower portion of second member from open position to engaged position, by pivoting it around the axle.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

The present invention relates to a universal apparatus which is very useful to build fixtures and frames out of component kits used in the tooling and measuring industry. It is practical and useful in the medical industry as a surgical apparatus as part of retractor systems to provide exposure of an operative site, The universal cam-operated joint apparatus is sturdy, readily adjustable, easy to use, when it is made out of special materials like different grades of stainless steel the device easily sterilizable. It is well suited for use in conjunction with operating room tables.

In surgical operations, some type of retraction apparatus is needed to access internal organs and bone structures. Variance in types of surgery and patient size necessitate a device which is both adjustable and sturdy. For general and specialty retractor systems universal motion, easy placement, adjustment, and cleaning are key factors of successful surgery. Equipment sterilization requirements necessitate a device which can be thoroughly cleaned by conventional means in a safe and easy manner.

During many surgical procedures, operating rooms utilize table mounted mechanical retractors. This eliminates the need for operating room personnel to hold the retractors during the surgical procedure and allows more detailed retraction planning when multiple blades are required for the surgery. The table mounted retractor allows the retractor blades be mounted to a frame that is mounted to the operating room table. The frame is erected around the operating field and then remains there throughout the procedure.

Universal retractors generally utilize rail clamps, extension arms, universal clamps and retractor blades. Some of the rail clamp commonly used may not be secured to an operating table without breaking the sterile field. During surgery, repositioning of this rail clamp must be performed by a non-sterile circulating nurse, thereby increasing the duration of the surgery.

In addition, universal surgical retraction devices utilize connecting joint mechanisms, such joint mechanisms consist of several parts which allow the surgeon to swivel and/or rotate the retractor blades into place. Examples of such devices are disclosed in U.S. Pat. Nos. 3,221,743, 4,617,916, and 5,025,780.

Moving such retractor blades requires loosening the universal joint, moving the retractor blade and then re-tightening the joint. It is greatly desirable to have a universal joint mechanism which permits quick tightening of the joint and ease of movement of the retractor blade and allow placement of the device between fixtures.

The rigidity of the frame provides a strong, stable platform to mount retractor blades. Versatility is key factor for these systems. Because the desired exposure is not always directed to the center of the operating site, many times retractors are needed to be positioned to elevate or push down on the margins of the incision. The rigidity of the frame limits the exact placement of the retractor blades especially with ring type retractors

These retractors utilize a universal joint to connect the retractor blade to the frame. The universal joint provides the surgeon with greater flexibility in blade placement. The universal joint disclosed in a table mounted retractor in U.S. Pat. No. 3,221,743 describes a joint made up of two clamping members, a conical bushing, and a means for providing compressive forces. A similar clamp design is shown in the LeVahn patents mentioned above.

Many of the universal joints are quite strong and versatile; however, if the surgeon wishes to add a retractor blade between two secured components, it is impossible to do so. To make it easier to add retractors between secured components, LeVahn developed a split universal joint shown in U.S. Pat. Nos. 4,617,916, 4,718,151, and 4,917,707. The split universal joint allows retractors to be added to the frame between secured components. To overcome the split joints slipping problem, LeVahn disclosed a hinge clamp in U.S. Pat. No. 5,020,195 which encircles the frame arm giving the joint additional strength. The problem with many of the previous designs that they are cumbersome to use and once they are on the frame arm, it can be difficult to slide or position them. Many of the referenced or previous clamp devices incorporate a thread clamping means which requires lubrication and maintenance.

### BRIEF SUMMARY OF THE INVENTION

It is therefore an advantage of the present invention to provide a universal cam operated joint capable of clamping to fixture bars or frames between secured components. The apparatus implements a cam locking mechanism for quick set up and adjustments.

It is another advantage of the present invention to provide a joint that has a locking, floating handle design to allow the user to position the handle in any direction to avoid interfering with use.

The present invention is to provide connecting joint mechanism that is easy to use and permits quick release or adjustment. The device is specially useful for surgical retractors and mechanical support applications.

### DETAILED DESCRIPTION OF THE SEVERAL VIEWS OF THE DRAWING

FIG. 1 is a perspective view of an embodiment of the universal cam-operated joint of the present invention.

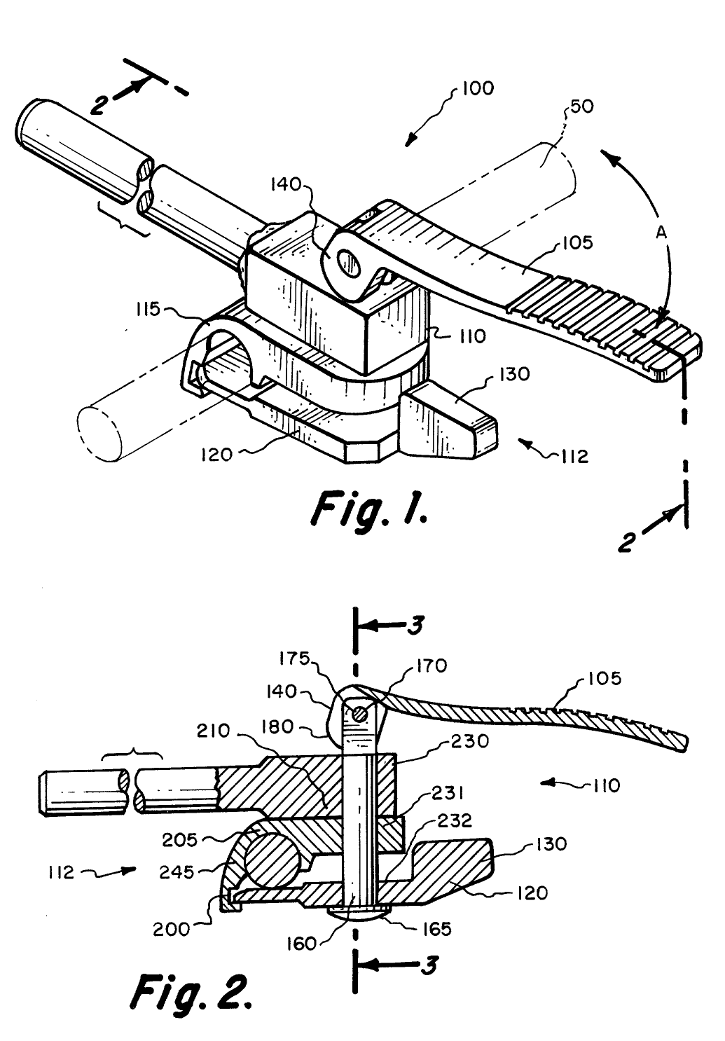

FIG. 2 is a side view, in partial cross-section of an embodiment of the universal cam-operated joint of the present invention.

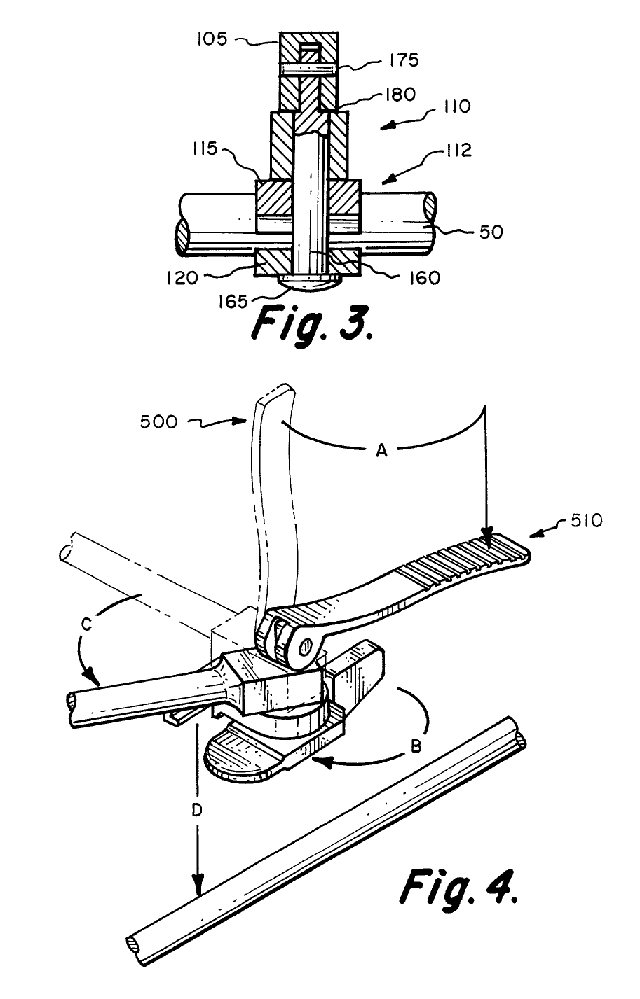

FIG. 3 is a cross-sectional side view of an assembly portion of the embodiment of the universal cam operated joint of FIG. 2.

FIG. 4 are perspective view illustrating successive steps of operating an embodiment of the universal cam operated joint to connect it to a mechanical fixture bar of FIG. 1.

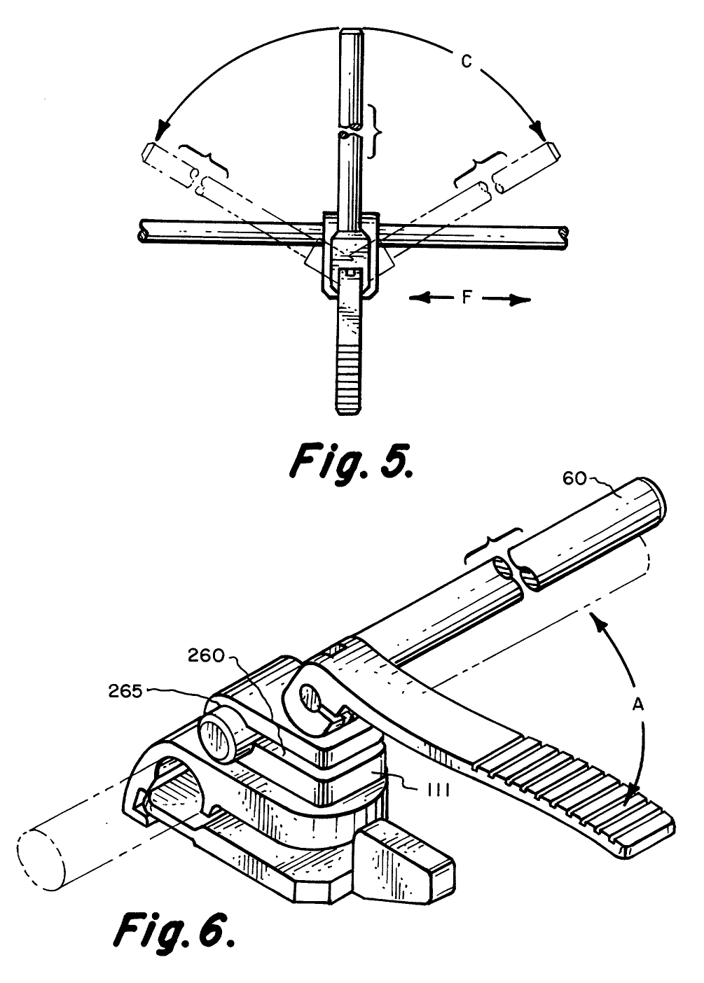

FIG. 5 top elevation view further illustrating the operation of an embodiment of the universal cam-operated joint of the present invention including a mechanical fixture bar connected thereto.

FIG. 6 is perspective view of an embodiment of the universal cam-operated joint of the present invention with an alternate first clamping member.

### DETAILED DESCRIPTION OF THE INVENTION

FIG. 1 is a perspective view of an embodiment of the universal cam operated joint of the present invention. The universal joint is referenced generally at 100. The universal joint 100 comprises unitary construction of a cam locking mechanism 105, a first clamping member 110, a second clamping member 112 having an upper portion 115 and a. lower portion 120.

The cam locking mechanism 105 also has a cam 140, the operation of which is described further below (FIGS. 2 and 3). A mechanical fixture bar 50 is illustrated which universal joint is referenced generally at 100 is attached to.

FIG. 2 is a side view including hidden lines illustrating the embodiment of the universal cam operated joint 100 of FIG. 1, wherein like numerals represent like parts. FIG. 2 further includes a stud 160 arranged to align and connect the cam 140 to the first clamping member 110 and the upper and lower portion 115, 120 of the second clamping member 112 by means of a head 165. The stud 160 also includes an cross hole portion 170 for accepting an axle 175 about which the cam 140 pivots. The cam 140 pivots a cam surface 180. The cam surface 180 engages to contact surface of first clamping member 110 which is preferably an anti-galling one.

A detent 200 is formed in the upper portion 115 of the second clamping member 112. The lower portion of second member 120 is seated in the detent 200 when in a locked position. There is an engagement surface 205 in the upper portion 115 of the second clamping member 112 which is preferably a non slipping surface.

The engagement surface 205 contacts 210surface of first clamping member 110 which has preferably a non slipping type as well.

A notch 245 is formed in the upper portion 115 of the second clamping member 112. Further a trough bore is provided in all tree members, 230 in first clamping member 110, 231 the upper portion 115 of second member 112, and 232 in the lower portion 120 of second member 112. Through bores 230, 231, and 232 allow the stud 160 to pass through on the tree members and keeping them together.

The lower portion of second member 120 further comprises a handle portion 130 in order to pivot the member around axle 160 by the user.

FIG. 3 is a cross view of the joint assembly of FIG. 2, wherein like numerals represent like parts. For example, the first clamping member 110, the stud 160, mechanical fixture bar 50, the upper portion 112 and the lower portion 115 of second member 120 are shown.

FIG. 4 illustrate how the embodiment of the universal cam operated joint 100 of FIGS. 1-3 is operated in a typical procedure. The figure illustrates mechanical fixture bar 50 (see FIG. 1) and universal joint 100. The user manipulates cam locking mechanism 105 so that the cam 140 is in an up or open position as shown 500.

This enables first clamping member 110, upper portion 115 of second member 112 and a. lower portion 120 of second member112 to pivot around axle 160. The user can slip the upper portion 115 over mechanical fixture bar 50 when lower portion 120 of second member 112 is positioned the way it is disengaged from recess 200, called open position see arrow D. User rotates member 120 to the open or the engaged position by pivoting it in direction of arrow B. The lower portion 120 of the second clamping member 112 is rotated into engaged position when member 120 comes to rest in the detent 200, formed in the upper portion 115 of the second clamping member 112. When the lower portion 120 of the second clamping member 112 is the engaged position the joint 100 is now initially arranged for operation.

Locking operation is performed, once the a first clamping member 110 and second clamping member 112 are properly positioned , rotating the handle 130 as indicated by arrow A to a desired location 510, locking the cam 140 via the pressure of the cam surfaces 180 against the contact surface of first clamping member 110. This locks the cam universal joint 100 in place.

Locking the cam 140 (locked position 510) axle head 165 compresses all members connected by axle 160. The compression created between first clamping member 110 and upper portion 115 of the second clamping member 112 prevents engagement surfaces from sliding. The pressure applied to the lower portion 120 of the second clamping member 112 at trough bore area 232 pivots it around detent 200. The pivoting movement of the lower portion 120 of the second clamping member 112 created by pressure at trough bore 232 area, presses and locks the mechanical fixture bar 50 against notch 245 formed in the upper portion 115 of the second clamping member 112.

The axle 160 becomes locked against rotation result of the pressure between engagement surfaces of axle head 165 and the lower portion 120 of the second clamping member 112.

Arrow C indicates direction of motion of first swivel member 110, while cam 140 is in unlocked position 500.

The beneficial feature of the floating cam locking mechanism 105 illustrated in open position 500 and locked position 510, which allows positioning the cam locking mechanism 105 away from the user. Open position 500 and locked position 510 of the cam locking mechanism 105 are rotated 90 degree in reference to the mechanical fixture bar 50.

FIG. 5 further indicate the manipulation of the universal cam-operated joint 100 showing how the universal joint 100 is adjustably positionable along the mechanical fixture bar as indicated by Arrow F.

In addition shown the way as first clamping member 110 is adjustable toward and away from the mechanical fixture bar 50 as indicated by Arrow C.

FIG. 6 is perspective view of an embodiment of the universal cam-operated joint of the present invention with an alternate of first clamping member 111. The alternate first clamping member 111 has details described for first clamping member 110. Furthermore it has leg portions 260 and a clamping bore 245 formed to except a mechanical fixture bar 60. Locking the cam 140 mechanical fixture bar 60 become frictionally locked in clamping bore 245.

While particular elements, embodiments and applications of the present invention have been shown and described, it will be understood, of course, that the invention is not limited thereto since modifications may be made by those skilled in the art, particularly in light of the foregoing teachings. It is therefore contemplated by the appended claims to cover such modifications as incorporate those features which come within the spirit and scope, of the invention.

What we claim is:

1. A universal joint apparatus comprising:
Cam locking mechanism;
First clamping member;
Second clamping member having an upper portion and a lower portion arranged adjacent to each other;
Lower portion of second clamping member selectively engages the upper portion of the second clamping member; and
Through rod connecting the first clamping member and the second clamping member of the cam locking mechanism.

2. The apparatus of claim 1 wherein the lower portion of second clamping member rotates between at least a first position and a second position so that the lower portion of second clamping member engages the upper portion second clamping member portion when in the second position.

3. The apparatus of claim 4 wherein the upper portion of second clamping member has a recess for accepting part of the lower portion of second clamping member.

4. The apparatus of claim I wherein the cam locking mechanism comprises:
handle; and
a cam connected to the handle and pivotally connected to the through rod so that the cam engages the first clamping member when selectively positioned by using the handle.

5. The apparatus of claim 1 wherein the second clamping member has a notch portion.

6. The apparatus of claim I wherein the through rod further comprises a cross hole portion thereof.

7. The apparatus of claim 10 further comprising an axle arranged in the cam locking mechanism, the axle passing through the cross hole portion of the through rod.

8. The apparatus of claim 1 wherein the cam locking mechanism, the first clamping member and the second clamping member are independently rotatable with respect to each other.
